(19) United States
(12) Patent Application Publication
(10) Pub. No.: US 2015/0037128 A1
(43) Pub. Date: Feb. 5, 2015

(54) Monolithic magnets with magnetic field domains for diamagnetic levitation

(71) Applicant: Gerald Küstler, Gaggenau (DE)

(72) Inventor: Gerald Küstler, Gaggenau (DE)

(21) Appl. No.: 13/958,566

(22) Filed: Aug. 4, 2013

(51) Int. Cl. F16C 32/04; H01F 7/02; H02N 15/00; B01L 3/00

(52) U.S. Cl. CPC F16C 32/0408; B01L 3/502784; B01L 3/50273; H01F 7/0273; H02N 15/00; B01L 2400/043; B01L 2200/0626
USPC 414/749.2

(57) ABSTRACT

The invention comprises a monolithic magnet or a combination of monolithic magnets with magnetic field domains for diamagnetic levitation of diamagnetic objects wherein the magnetic field pattern, the magnetic field strength and the magnetic field gradient of the magnetic field domains are chosen in such way that levitation of diamagnetic objects is achieved.

This application claims the benefit of U.S. Provisional Application No. 61/742,279 filed Aug. 7, 2012.

### BACKGROUND OF THE INVENTION

1. Field of the Invention The present invention relates generally to a method for achieving levitation of diamagnetic objects with the support of magnetic fields.

2. Description of Related Art

The Chinese patent application CN101216309A, referenced as [1] in the following, discusses the use of diamagnetic levitation in micro gyroscopes. FIG. 7 of [1] shows a circular shaped diamagnetic levitation track with a number of concentric ring magnets with opposing magnetic field.

The U.S. Pat. No. 3,493,274A, referenced as [2] in the following, claims magnetic support systems based on the diamagnetic levitation effect. FIG. 3 of [2] shows a diamagnetic levitation array consisting of a number of block magnets with opposing magnetic field.

The U.S. Pat. No. 6,361,268B1, referenced as [3] in the following, claims a friction less transport apparatus and method based on diamagnetic levitation. FIG. 5a of [3] shows an elongated diamagnetic levitation track with a number of magnets with opposing magnetic field.

The patent application WO2007125129A1, referenced as [4] in the following and the patent application US20020106314A1, referenced as [5] in the following, describe the use of the diamagnetic levitation effect in micro-fluid processing chips respectively for labs-on-chip.

The paper “On-Chip Manipulation of Levitated Femtodroplets”, Appl. Phys. Lett., 85, 1817-1819 (2004), referenced as [6] in the following, describes the on-chip manipulation of levitated femtodroplets, using the effect of diamagnetic levitation. References [1]-[6] use primarily several single magnets with opposing fields in combination to achieve a sufficient magnetic field pattern, magnetic field strength and field gradient for achieving diamagnetic levitation. There is the disadvantage of manufacturing and coating every single magnet and assembling the magnets afterwards which increases manufacturing costs. Reference [4] shows in FIGS. 30b, 30d, 30e, 30f and 30g monolithic magnets with uniform axial or radial magnetization and special geometry for levitation of diamagnetic objects. Here, stable levitation of the diamagnetic objects over one single monolithic magnet with uniform magnetization is only possible because of the additional special geometry in the magnets e.g. holes or grooves, which are providing the necessary magnetic field gradient for diamagnetic levitation. A magnetic potential well is realized by such geometries. To realize the holes and grooves, additional manufacturing steps are necessary which adds to manufacturing costs. A further disadvantage of such magnets from [4], with a special geometry, is the fact that these magnets have to be very small for achieving diamagnetic levitation and can only levitate diamagnetic objects with dimensions in the pm range e.g. tiny water droplets.

The US patent application US20120038440A1, referenced as [7] in the following, describes a method for magnetizing monolithic magnets in specific patterns with an advanced “printing” technology.

### BRIEF SUMMARY OF THE INVENTION

The term “monolithic magnet” is used above and in the following. The definition of “monolithic magnet” is hereby: A single magnet; consisting of one piece.

The invention comprises a monolithic magnet or a combination of monolithic magnets with magnetic field domains for diamagnetic levitation of diamagnetic objects wherein the magnetic field pattern, the magnetic field strength and the magnetic field gradient of the magnetic field domains are chosen in such way that levitation of diamagnetic objects is achieved. In comparison to the prior art solutions, the invention allows the easier, faster and cheaper production of e.g. diamagnetic levitation tracks or diamagnetic bearings. Furthermore, with the invention, one can realize diamagnetic levitation tracks, which otherwise are difficult or impossible to be realized using prior art technologies.

### BRIEF DESCRIPTION OF THE SEVERAL VIEWS OF THE DRAWINGS

FIG. 1 shows a prior art circular diamagnetic levitation track.

FIG. 2 shows a prior art diamagnetic levitation array.

FIG. 3 shows a prior art elongated diamagnetic levitation track.

FIG. 4 shows a first embodiment of the invention. Here a circular diamagnetic levitation track is demonstrated.

FIG. 5 shows a further embodiment of the invention. A monolithic block magnet is magnetized with n magnetic domains with opposing fields in checker-board fashion.

FIG. 6 shows a further embodiment of the invention. Here, a diamagnetic object floats over a monolithic cylinder magnet which is magnetized with n magnetic domains with opposing fields in checker-board fashion.

FIG. 7 shows an elongated diamagnetic levitation track as a further embodiment of the invention.

FIG. 8 shows a counterintuitive diamagnetic levitation track on a monolithic block magnet as a further exemplary embodiment of the invention.

FIG. 9 shows a further embodiment of the invention. Here a cylindrical magnet is magnetized with n circular-shaped magnetic domains surrounded by non-magnetic domains.

FIG. 10 shows components for building diamagnetic levitation tracks in a more effective way as a further exemplary embodiment of the invention.

FIG. 11 shows a circular diamagnetic levitation track build with ring-arc shaped monolithic magnets shown in FIG. 10 as a further exemplary embodiment of the invention.

FIG. 12 shows a combination of the arc-shaped monolithic magnets with block-shaped monolithic magnets to realize an oval diamagnetic levitation track in modular form as a further exemplary embodiment of the invention.

FIG. 13 shows an embodiment of the invention wherein a number of arc-shaped monolithic magnets form a curved diamagnetic levitation track.

FIG. 14 shows a similar embodiment as already shown in FIG. 7, but additionally with an implemented stopper geometry to prevent the diamagnetic object from leaving the diamagnetic levitation track in axial direction.

FIG. 15 shows a concave shaped diamagnetic levitation track as a further exemplary embodiment of the invention.

FIG. 16 shows a further embodiment for preventing the levitating diamagnetic object from leaving the track including a magnetic potential well.

FIG. 17 shows the use of the invention for building micro-fluid processing chips.

### DETAILED DESCRIPTION OF THE INVENTION

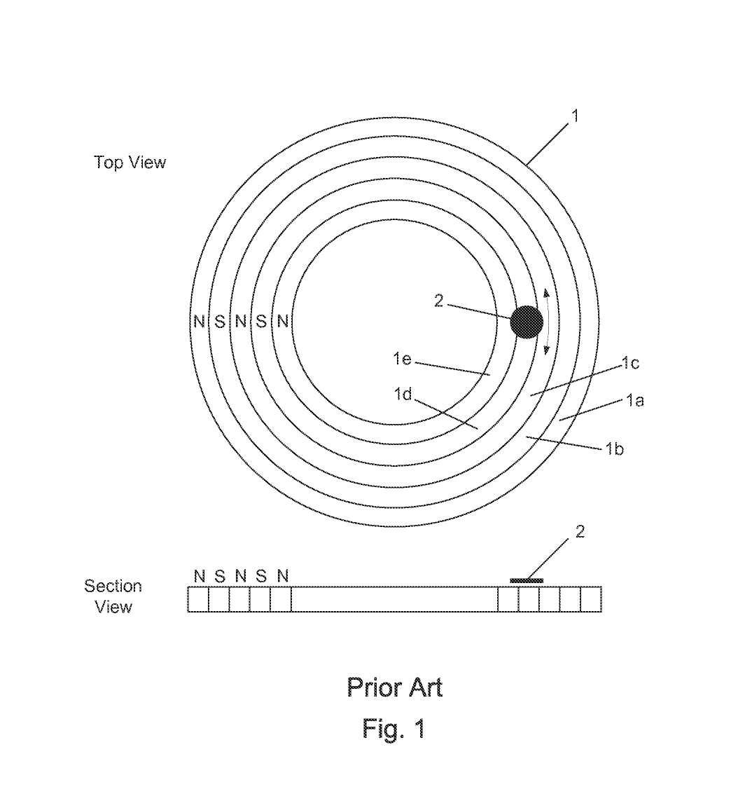

FIG. 1 shows a prior art circular diamagnetic levitation track as e.g. shown in reference [1]. In this example a magnet array 1 consists of five ring magnets (1a-1e) which are attached onto each other with opposing magnetic field indicated by N for magnetic North pole and S for magnetic South pole. Such an arrangement produces a magnetic field and field gradient strong enough for the levitation of a diamagnetic object. In this case, the magnetic field geometry is rotation-symmetric and the levitating diamagnetic body 2, e.g. pyrolytic graphite, can levitate freely along a circular track. Disadvantage of the shown arrangement is that one needs five different single ring magnets which have to be manufactured with high precision so that the ring magnets fit into each other without a too large air gap between the ring magnets. Manufacturing of suitable ring magnets is therefore time-consuming and cost-intensive. Every single ring magnet has to be manufactured, magnetized and coated for its own. And finally the ring magnets have also to be assembled which is also time consuming and whereas also the risk exists that the thin magnets get easily broken.

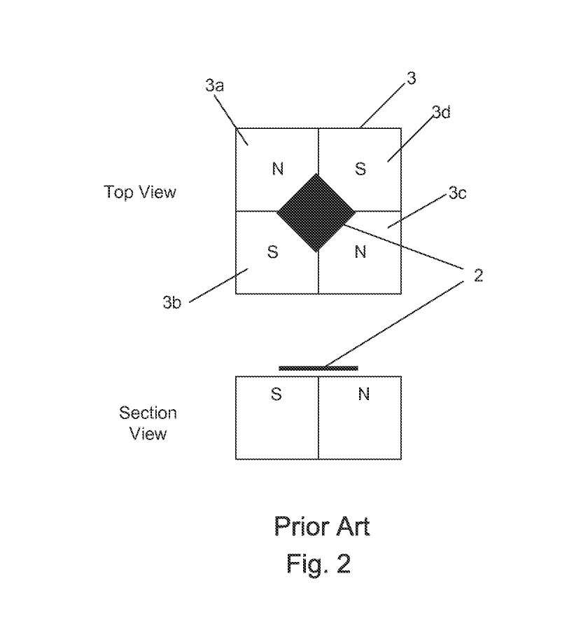

FIG. 2 shows a prior art diamagnetic levitation array 3 as mentioned in reference [2]. In this example, four block magnets (3a-d) are attached onto each other with opposing magnetic fields and build a magnet array 3. This arrangement also produces a sufficiently strong magnetic field and field gradient so that a diamagnetic object 2 can be levitated above the magnets surface. As already mentioned above, there is again the disadvantage of manufacturing and coating every single magnet and assembling the magnets afterwards.

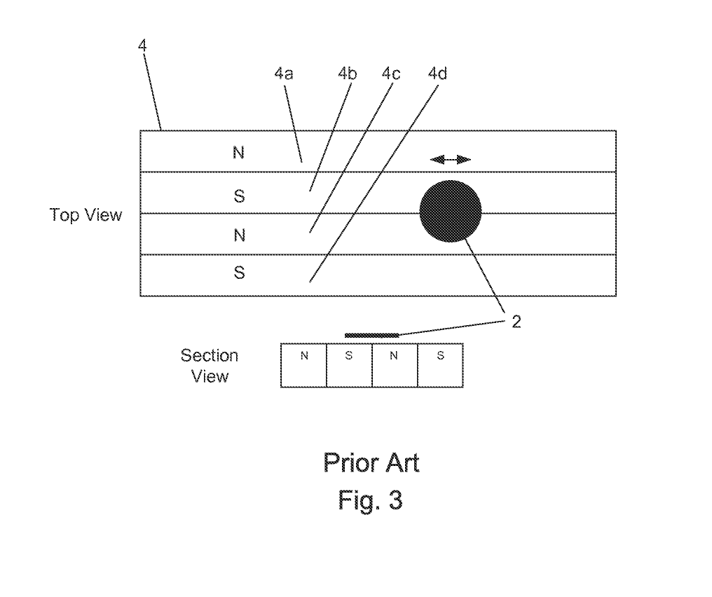

FIG. 3 shows a prior art elongated diamagnetic levitation track 4 as described in reference [3]. In this special case four narrow and long block magnets (4a-d) are attached onto each other with opposing magnetic fields. The magnetic field and field gradient are formed in such way that the free levitation and movement of diamagnetic objects is possible parallel to the axis of the magnets. Again, for such an arrangement numerous single magnets are needed. Manufacturing and assembly is cost-intensive. Therefore there was a need for developing diamagnetic levitation bases which can be manufactured for a lower price and where manufacturing time and assembly time is drastically reduced.

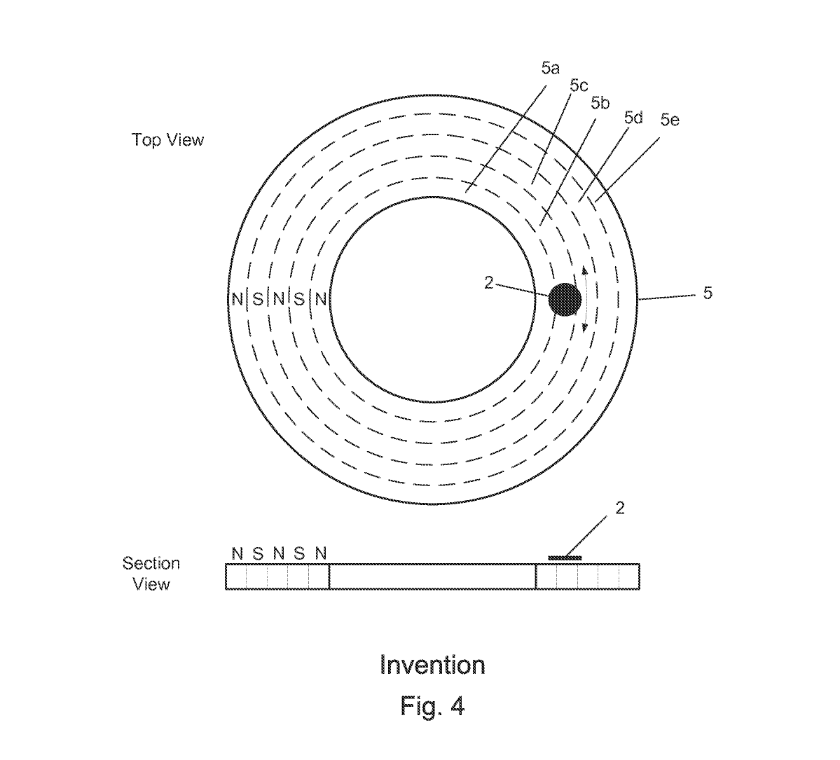

FIG. 4 is a first exemplary embodiment of the invention. Here a circular diamagnetic levitation track is demonstrated. One single monolithic ring magnet 5 is magnetized with e.g. five opposing ring-shaped magnetic domains (5a-e). The domain borders are visualized with dotted lines. The diamagnetic object 2 levitates over the ring magnet 5. So, when manufacturing such a levitation track one would only need one single monolithic magnet. All the manufacturing steps for manufacturing several single ring magnets, as shown in FIG. 1, fall apart. Also, no assembly time is needed as, after magnetization, the levitation track is ready. Diamagnetic objects can be levitated freely above the monolithic ring magnet in the same way as described in the prior art. As the surface of the monolithic magnet is also smaller than the surface of the five assembled ring magnets shown in FIG. 1, the surface coating costs with e.g. Ni—Cu—Ni are lower. Preferably, the magnets are made of modern magnetic materials like NdFeB with grade N25 to N52 or higher. An alternative are samarium-cobalt-magnets which also show high magnetic remanence. The magnetization of the domains can be realized with methods described in reference [7] or with other well known methods. In a known manner, the monolithic magnets can be set on a ferromagnetic surface to enhance magnetic field strength and reduce flux leakage. The diamagnetic object 2 can be made e.g. from graphite or pyrolytic graphite, materials which are lightweight and show strong diamagnetic properties. As superconductors are perfect diamagnets, superconductors are also included in this invention. Typical levitation height of pyrolytic graphite is in the range of 0.5 mm to 2 mm with strong NdFeB magnets and optimized field geometries. In the future, with even stronger magnetic and diamagnetic materials, the levitation gap can be further increased.

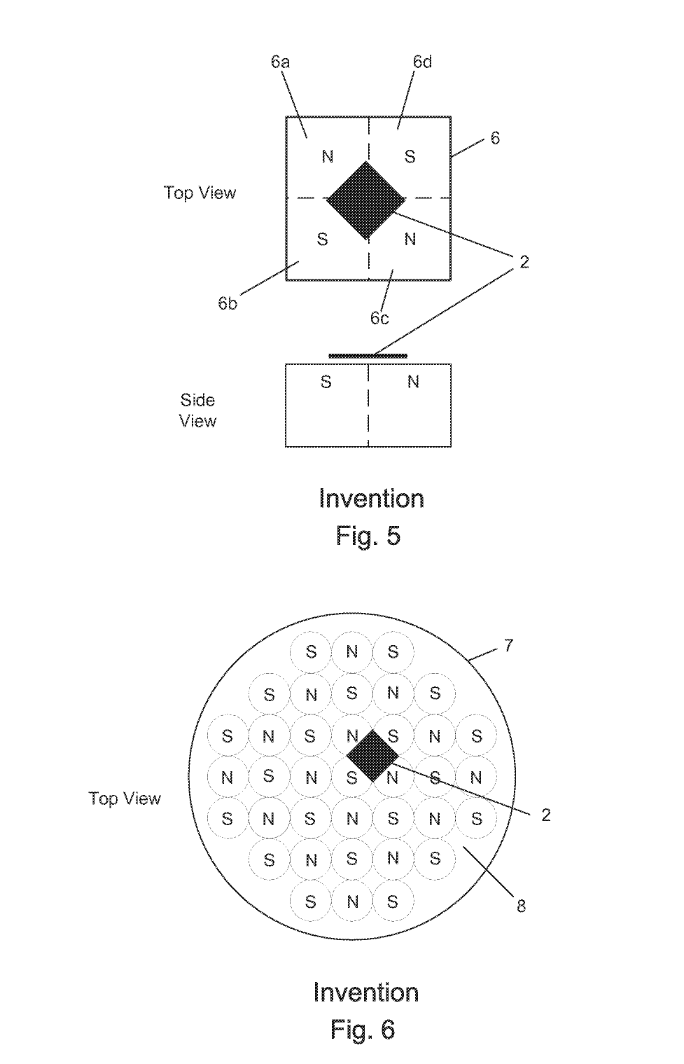

FIG. 5 shows a further exemplary embodiment of the invention. A monolithic block magnet 6 is magnetized with n magnetic domains with opposing fields in checker-board fashion, in this case with four magnetic domains 6a-6d. This also generates a magnetic field and field gradient which are sufficient for diamagnetic levitation. As mentioned before, here also one monolithic magnet can replace n single magnets with the advantage of decreasing manufacturing and assembly costs.

FIG. 6 shows a further exemplary embodiment of the invention. Here, a diamagnetic object 2 floats over a monolithic cylinder magnet 7 which is magnetized with n magnetic domains with opposing fields in checker-board fashion. The domains can be circular or can have another suitable form. The magnetic domains can be surrounded by a non-magnetized domain 8.

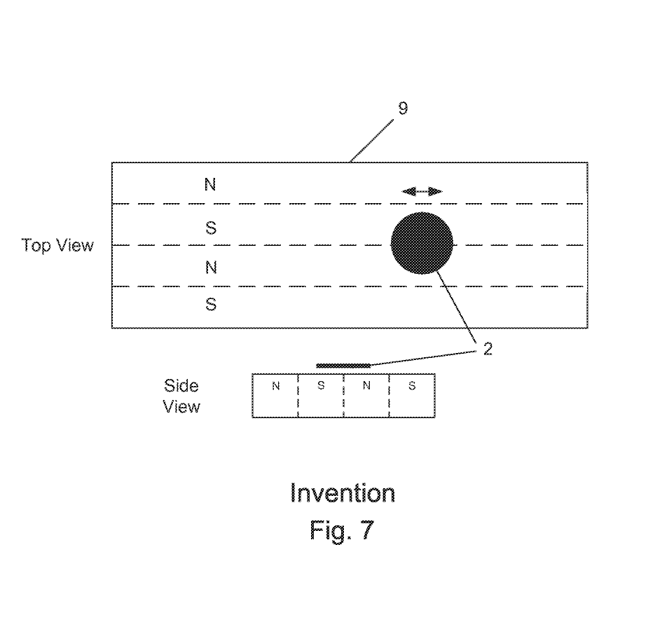

FIG. 7 is a further exemplary embodiment of the invention showing an elongated diamagnetic levitation track. In this case, a long block magnet 9 is magnetized with n long and narrow magnetic domains with opposing magnetic field, here e.g. four magnetic domains. This kind of magnetization generates elongated potential wells wherein diamagnetic objects can be levitated parallel to the magnet axes as indicated with the double arrow.

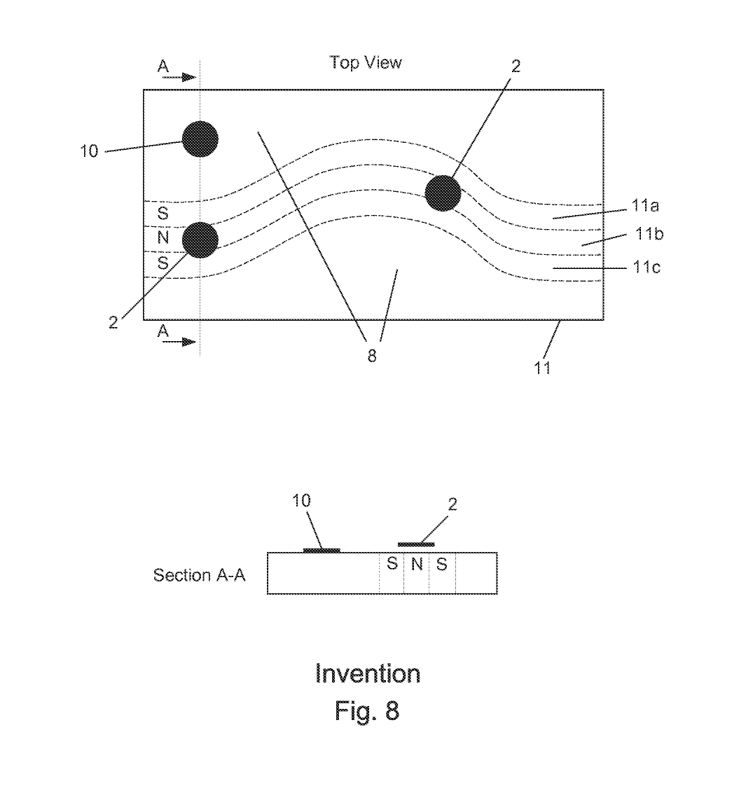

FIG. 8 shows as a further exemplary embodiment of the invention a counterintuitive diamagnetic levitation track on a monolithic block magnet 11. The block magnet 11 is magnetized with n curved magnetic domains with opposing magnetic fields, e.g. with four magnetic domains 11a-c. The magnetic domains are surrounded by a non-magnetized domain 8. A diamagnetic object 2 would freely float along the path of the curved magnetic domains, but would of course not float on non-magnetized domains. 10 marks the non-levitating diamagnetic object. So, viewers would only see a monolithic magnet and would wonder why the diamagnetic object is floating above the magnet surface in a curved way but would not float on certain locations of the magnet. This would be a magnet with “Wow-Effect”. People would wonder how this can work.

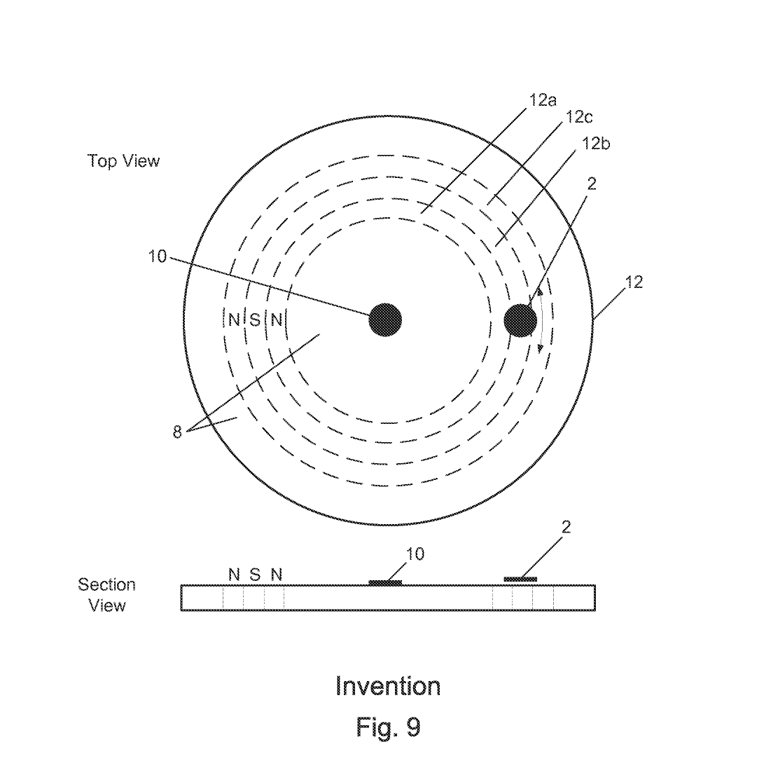

FIG. 9 is a further exemplary embodiment. Here a cylindrical magnet 12 is magnetized with n circular-shaped magnetic domains surrounded by non-magnetic domains 8. In the presented example, there are three magnetic domains (12a-c) with opposing field. So, a diamagnetic object 2 would float along a circular path in the middle of the magnet but a diamagnetic object 10 would not float in the center or border region of the magnet surface where the non-magnetic domains are located. Not knowing about this phenomenon and the magnetized domains, it is hardly to explain how this could work—a further “Wow-Effect”.

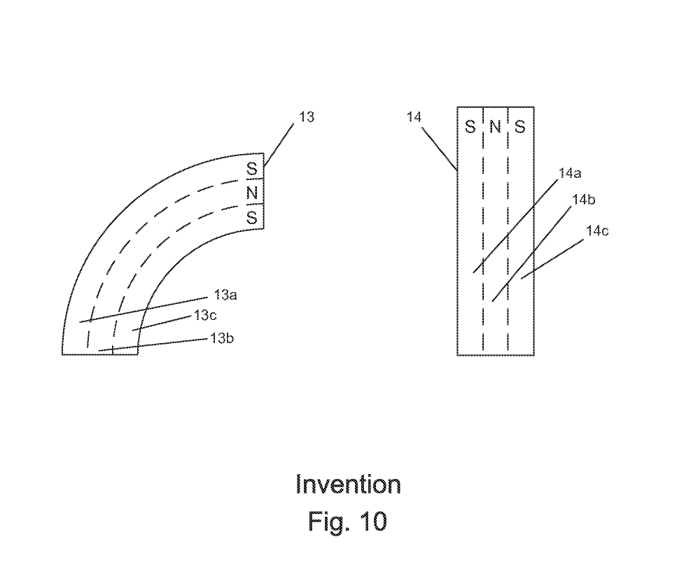

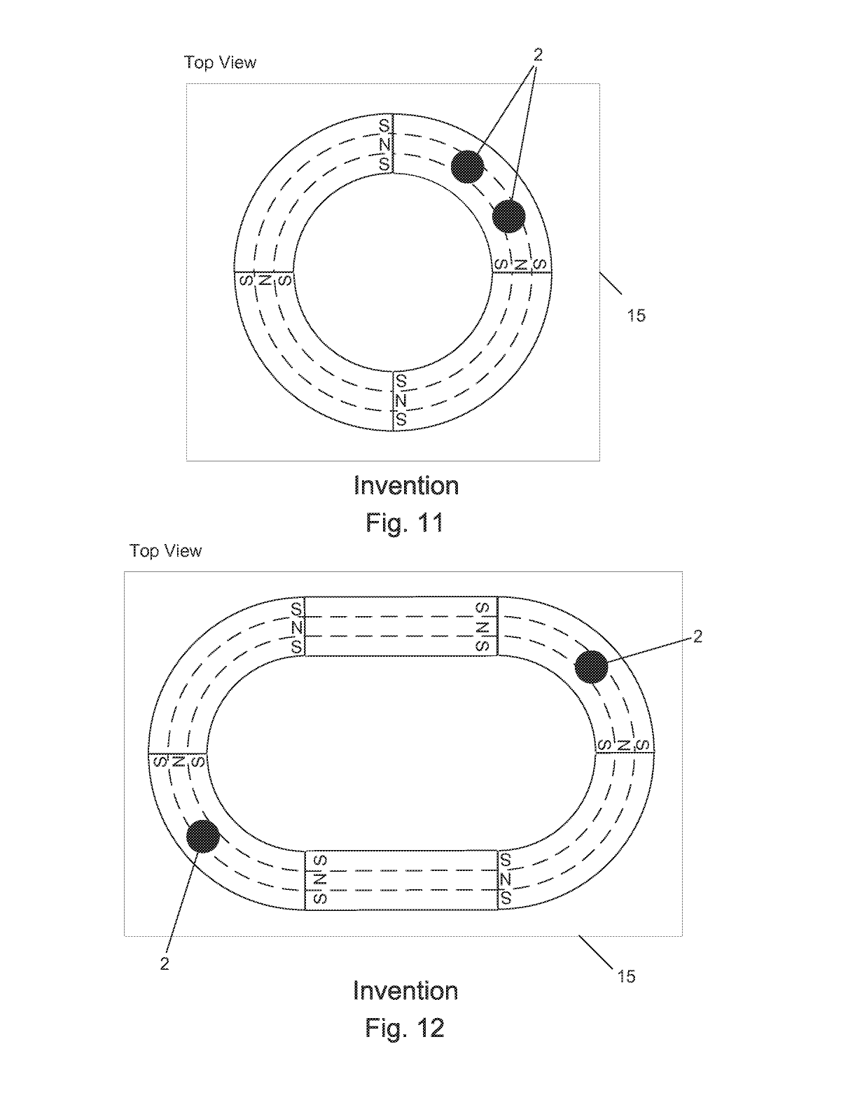

FIG. 10 shows components for building diamagnetic levitation tracks in a more effective way according to the invention. The components are e.g. a ring arc segment 13 and a block segment 14, both magnetized with n magnetic domains with opposing fields as already described before. In the presented example there are three magnetic domains 13a-c respectively 14a-c. As shown in FIGS. 11, 12 and 13 these monolithic magnets can be used to assemble diamagnetic levitation tracks for the use in toy construction kits.

FIG. 11 shows as a further exemplary embodiment of the invention a circular diamagnetic levitation track build with ring-arc shaped monolithic magnets 13 known from FIG. 10. Normally, with prior art technology, one would need in this example 12 arc-shaped single magnets to build such a track in the way of a construction kit. With the invention the number of necessary magnets is reduced from 12 to 4. Considering five parallel magnetic domains instead of the shown three, one would need 20 single magnets with the prior art technology, but again only 4 with the invention. The monolithic magnets are attached to a ferromagnetic base 15 for fixation.

FIG. 12 shows a combination of the arc-shaped monolithic magnets 13 with block-shaped monolithic magnets 14 from FIG. 10 to realize an oval diamagnetic levitation track in modular form. Such a combination of magnets could be offered as construction kit in a toy or scientific experimental kit.

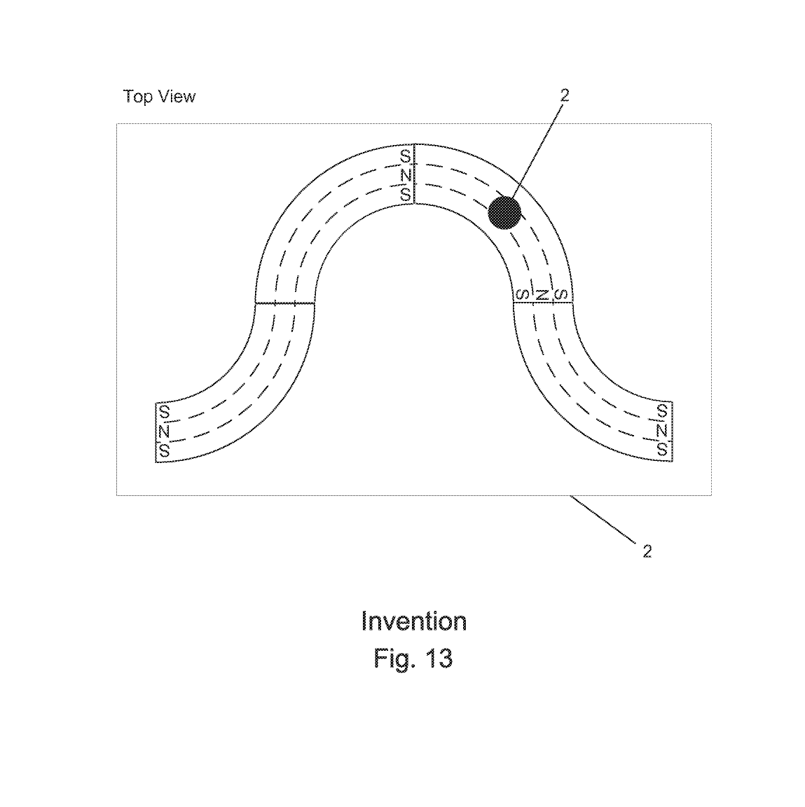

FIG. 13 demonstrates a further exemplary embodiment of the invention wherein several arc-shaped monolithic magnets 13 from FIG. 10 form a curved diamagnetic levitation track. The diamagnetic object(s) 2 would also freely levitate along and above such magnetic paths. Beside the already mentioned solutions, other variations and combinations are thinkable.

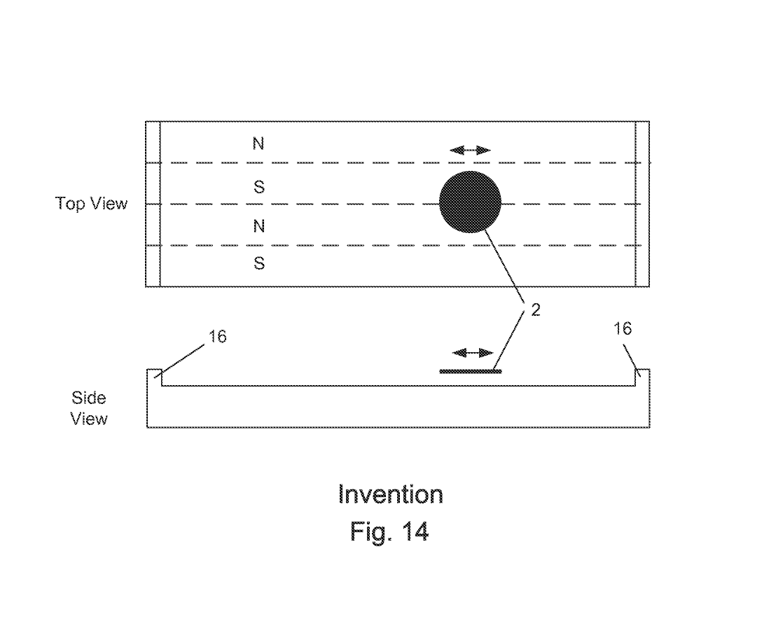

FIG. 14 shows a similar embodiment as already shown in FIG. 7 but additionally with an implemented stopper geometry 16 to prevent the levitating diamagnetic object from leaving the diamagnetic levitation track in axial direction.

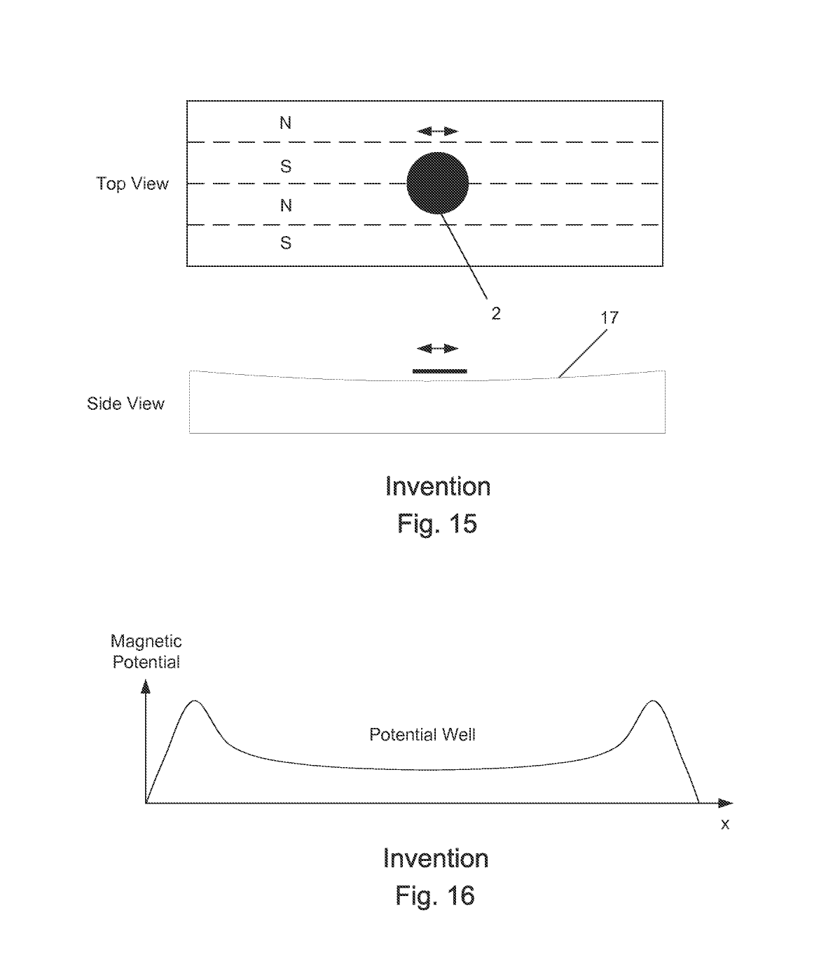

FIG. 15 shows a similar embodiment as already shown in FIG. 7 but additionally the diamagnetic levitation track has now a concave shape 17 to prevent the levitating diamagnetic object from leaving the diamagnetic levitation track in axial direction. A potential well is realized in this way.

FIG. 16 shows a further exemplary embodiment for preventing the levitating diamagnetic object from leaving the track. The monolithic block magnet must be magnetized in such way that there is realized a magnetic potential well parallel to the magnetic field domains as shown in FIG. 16.

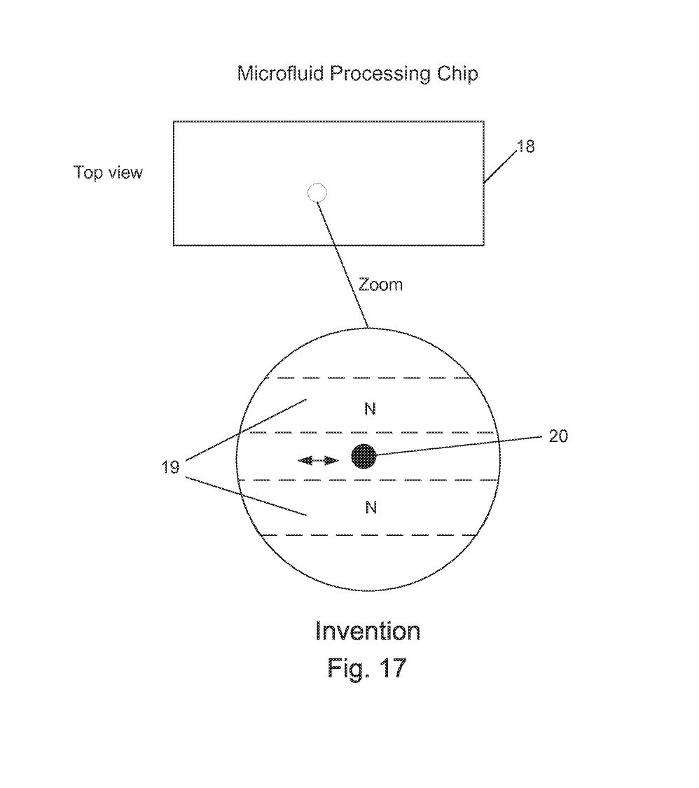

FIG. 17 demonstrates the use of the invention for building micro-fluid processing chips. In this case, several magnetic field domains 19 with micrometer to nanometer size are realized onto the surface of a monolithic magnet 18. Due to these magnetic domains 19, the levitation of tiny diamagnetic particles or fluids 20 is possible. These levitating fluids can be processed and moved in manners known from references [4-6].

The above described invention can be used for example for the following purposes:
Diamagnetic levitation tracks with a strongly reduced number of magnets
Use as a toy for building different diamagnetic levitation tracks in form of a construction set
As a base for highly sensitive sensors like accelerometers, tilt meters, gravimeters, force meters etc.
As a base for diamagnetic bearings
Realizing counterintuitive diamagnetic levitation tracks on a single monolithic magnet
Using these counterintuitive diamagnetic levitation tracks as advertising gifts or in science classes
Realizing micro fluidic processing chips onto such magnetized monolithic magnets

It will be appreciated that several of the above-disclosed and other features and functions, or alternatives thereof, may be desirably combined into many other different systems or applications. Also that various presently unforeseen or unanticipated alternatives, modifications, variations, or improvements therein may be subsequently made by those skilled in the art which are also intended to be encompassed by the following claims.

What is claimed is:

1. A system, comprising: a magnet or a combination of magnets with magnetic field domains for diamagnetic levitation of diamagnetic objects wherein the magnetic field pattern, the magnetic field strength and the magnetic field gradient of the magnetic field domains are chosen in such way that levitation of diamagnetic objects is achieved.

2. The system of claim 1, wherein the magnet or the magnets are monolithic magnets.

3. The system of claim 1, wherein the magnetic field pattern has the form of concentric circles with opposing magnetic field for realizing a circular diamagnetic levitation track.

4. The system of claim 1, wherein the magnetic field pattern includes magnetic field domains with opposing magnetic field in checker-board fashion.

5. The system of claim 1, wherein the magnetic field domains are rectangular, circular or have another arbitrary form.

6. The system of claim 1, wherein the magnetic field pattern includes long, narrow and parallel magnetic field domains with opposing magnetic field for realizing an elongated, linear diamagnetic levitation track.

7. The system of claim 1, wherein the magnetic field pattern comprises non-magnetized domains and curved magnetic field domains with opposing magnetic field for realization of a counterintuitive diamagnetic levitation track.

8. The system of claim 1, wherein the magnetic field pattern comprises non-magnetized domains and concentric circular magnetic field domains with opposing magnetic field for realization of a counterintuitive diamagnetic levitation track.

9. The system of claim 1, wherein the magnets have the form of a block or an arc segment with magnetic field domains with opposing magnetic field so that these blocks or arc segments can be used as segments in a construction kit.

10. The system of claim 9, wherein the block or arc segment shaped magnets are forming a circular or an oval or a curved diamagnetic levitation track and wherein these different diamagnetic levitation tracks can be combined to form other diamagnetic levitation track patterns.

11. The system of claim 1, wherein the magnets are attached to a ferromagnetic base.

12. The system of claim 1, wherein a stopper geometry is implemented into the magnet to prevent the levitating diamagnetic object from leaving the diamagnetic levitation track.

13. The system of claim 1, wherein the magnet is concave shaped to prevent the levitating diamagnetic object from leaving the diamagnetic levitation track.

14. The system of claim 1, wherein the magnet is magnetized in such way that there is realized a magnetic potential well to prevent the levitating diamagnetic object from leaving the diamagnetic levitation track.

15. The system of claim 1, wherein the magnets are made out of NdFeB or samarium-cobalt.

16. The system of claim 1, wherein the diamagnetic object or the diamagnetic objects are made out of pyrolytic graphite.

17. The system of claim 1, wherein a magnet or an assembly of such magnets are used for diamagnetic levitation tracks in toys.

18. The system of claim 1, wherein a magnet or an assembly of such magnets are used in sensor systems.

19. The system of claim 1, wherein a magnet or an assembly of such magnets are used for diamagnetic bearings.

20. The system of claim 1, wherein a magnet or an assembly of such magnets are used in a micro fluidic processing chip.
